(19) United States
(12) Patent Application Publication
(10) Pub. No.: US 2024/0412102 A1
(43) Pub. Date: Dec. 12, 2024

(54) MACHINE LEARNING ANALYSIS OF A RECORD

(71) Applicant: Capital One Services, LLC, McLean, VA (US)

(72) Inventors: Sophie BERMUDEZ, Bend, OR (US); Michael MOSSOBA, Great Falls, VA (US); Benjamin ASAMOAH, New York City, NY (US)

(21) Appl. No.: 18/333,018

(22) Filed: Jun. 12, 2023

(51) Int. Cl. G06N 20/00

(52) U.S. Cl. CPC G06N 20/00

(57) ABSTRACT

In some implementations, a device may retrieve a rule set, associated with an account, indicating one or more rules for associating a source, of a first source and a second source associated with the account, with an item based on item-level data of the item. The device may retrieve information, associated with the account, indicating one or more records that indicate first data at an exchange level of data. The device may analyze the first data associated with a record, of the one or more records, to determine item-level data for respective items of one or more items associated with the record. The device may determine, based on the rule set and the item-level data, sources associated with respective items of the one or more items.

### BACKGROUND

Machine learning is a field associated with building methods that “learn” (e.g., methods that leverage data to improve performance on some set of tasks). Machine learning algorithms build a model based on sample data, sometimes referred to as training data, in order to make predictions or decisions without being explicitly programmed to do so. Machine learning algorithms are used in a wide variety of applications, such as medicine, email filtering, speech recognition, and/or computer vision, among other examples, where it is difficult or unfeasible to develop conventional algorithms to perform the needed tasks.

### SUMMARY

Some implementations described herein relate to a system for using machine learning to analyze records. The system may include one or more memories and one or more processors communicatively coupled to the one or more memories. The one or more processors may be configured to retrieve a rule set, associated with an account, indicating one or more rules for associating a source, of a first source and a second source associated with the account, with an item based on a first level of data of the item. The one or more processors may be configured to retrieve information, associated with the account, indicating one or more records that indicate first data at a second level of data. The one or more processors may be configured to analyze, using a machine learning model, the first data in association with a record, of the one or more records, to determine second data, at the first level of data, for respective items of one or more items associated with the record. The one or more processors may be configured to determine, based on the rule set and the second data, sources, from the first source and the second source, associated with respective items of the one or more items. The one or more processors may be configured to modify, based on determining the sources to be associated with the respective items, the record to indicate the sources associated with the respective items. The one or more processors may be configured to store, in a data structure associated with the account, the record indicating the sources associated with the respective items.

Some implementations described herein relate to a method for allocating sources to items associated with records. The method may include retrieving, by a device, a rule set, associated with an account, indicating one or more rules for associating a source, of a first source and a second source associated with the account, with an item based on item-level data of the item. The method may include retrieving, by the device, information, associated with the account, indicating one or more records that indicate first data at an exchange level of data. The method may include analyzing, by the device, the first data associated with a record, of the one or more records, to determine item-level data for respective items of one or more items associated with the record. The method may include determining, by the device and based on the rule set and the item-level data, sources, of the first source and the second source, associated with respective items of the one or more items. The method may include modifying, by the device and based on determining the sources to be associated with the respective items, the record to indicate the sources associated with the respective items. The method may include storing, by the device and in a data structure associated with the account, the record indicating the sources associated with the respective items.

Some implementations described herein relate to a non-transitory computer-readable medium that stores a set of instructions. The set of instructions, when executed by one or more processors of a device, may cause the device to retrieve a rule set, associated with an account, indicating one or more rules for associating a source, of a first source and a second source associated with the account, with an item based on item-level data of the item. The set of instructions, when executed by one or more processors of the device, may cause the device to retrieve information, associated with the account, indicating one or more records that indicate first data at an exchange-level of data. The set of instructions, when executed by one or more processors of the device, may cause the device to analyze the first data associated with a record, of the one or more records, to determine item-level data for respective items of one or more items associated with the record. The set of instructions, when executed by one or more processors of the device, may cause the device to determine, based on the rule set and the item-level data, sources, of the first source and the second source, associated with respective items of the one or more items. The set of instructions, when executed by one or more processors of the device, may cause the device to modify, based on determining the sources to be associated with the respective items, the record to indicate the sources associated with the respective items. The set of instructions, when executed by one or more processors of the device, may cause the device to obtain, based on modifying the record, a contribution toward a total resource amount associated with the account, wherein the contribution includes a first contribution of a first portion of the total resource amount from the first source and a second contribution of a second portion of the total resource amount from the second source.

### BRIEF DESCRIPTION OF THE DRAWINGS

FIGS. 1A-1E are diagrams of an example associated with machine learning analysis of a record, in accordance with some embodiments of the present disclosure.

FIG. 2 is a diagram illustrating an example of training and using a machine learning model in connection with machine learning analysis of a record, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with machine learning analysis of a record, in accordance with some embodiments of the present disclosure.

FIG. 5 is a flowchart of an example process associated with machine learning analysis of a record, in accordance with some embodiments of the present disclosure.

### DETAILED DESCRIPTION

The following detailed description of example implementations refers to the

accompanying drawings. The same reference numbers in different drawings may identify the same or similar elements.

Some implementations described herein enable machine learning analysis of a record that indicates data at a first level of data to enable analysis of the record using data at a second level of data. For example, the record may indicate data at a first level of granularity and a system may need to make determinations associated with the record using data associated with the record at a second level of granularity. In some implementations, the system may analyze, using a machine learning model, data indicated by a record (e.g., data at a first level of data) to determine second data, at a second level of data, for respective items of one or more items associated with the record. As a result, the system is enabled to perform improved analysis of the record because the second data may provide more granular data regarding the record, enabling the system to make improved determinations associated with the record using the more granular data. This conserves processing resources, memory resources, computing resources, and/or network resources, among other examples, that would have otherwise been used to make determinations associated with the record using the data indicated by the record (e.g., at the first level of data or a less granular level of data). Further, this conserves processing resources, memory resources, computing resources, and/or network resources, among other examples, that would have otherwise been used to obtain data associated with the record at the second level of data (e.g., communicate with another device to receive or otherwise obtain data at the second level of data) to enable the system to make determinations associated with the record using the more granular data.

For example, the record may be associated with an account. In some examples, the account may be associated with multiple sources (e.g., multiple source accounts) that are associated with the account. A source (also referred to herein as a source account, a contribution account, or a source funding account) may be associated with crediting the account (e.g., a source may provide resources for contribution toward a total resource amount associated with the account). In some examples, a total resource amount associated with a record, associated with the account, may be partitioned, or allocated, to respective sources based on data at a first level of granularity (e.g., item-level data). However, the record may only indicate data at a second level of granularity (e.g., exchange-level data). For example, the record may only indicate data associated with an exchange and may not indicate information associated with one or more items that are associated with the record. Therefore, a system may be unable to correctly allocate portions of the total resource amount associated with a record to respective sources because the system may not have information regarding the item-level data of the record. This may result in the system allocating an incorrect portion of the total resource amount associated with the record to a given source. As a result, the system may consume processing resources, memory resources, computing resources, and/or network resources, among other examples, associated with communicating with a server device to indicate the incorrect portion to the given source, to obtain a contribution of the incorrect portion from the given source, and/or to correct the incorrect portion allocated to the given source, among other examples. Additionally, or alternatively, the system may consume processing resources, memory resources, computing resources, and/or network resources, among other examples, associated with obtaining the data at the first level of granularity (e.g., item-level data) associated with the record.

Some implementations described herein enable machine learning analysis of a record that indicates data at a first level of data to enable analysis of the record using data at a second level of data. For example, the system may obtain or retrieve a rule set, associated with an account, indicating one or more rules for associating a source, of a first source and a second source associated with the account, with an item based on a first level of data of the item. In some implementations, the system may analyze, using a machine learning model, data indicated by a record (e.g., data at a second level of data) to determine second data, at the first level of data, for respective items of one or more items associated with the record. As a result, the system is enabled to perform improved analysis of the record because the second data may provide more granular data regarding the record, enabling the system to make improved determinations associated with the record using the more granular data.

For example, the system may determine, based on the rule set and the second data, sources, from the first source and the second source, associated with respective items of one or more items associated with the record. In other words, the system may determine a single source, from the first source and the second source, for each item associated with the record. The system may modify, based on determining the sources to be associated with the respective items, the record to indicate the sources associated with the respective items. The system may store, in a data structure associated with the account, the record indicating the sources associated with the respective items. In some implementations, the system may provide, to a user device, display information to cause a user interface to be displayed, where the user interface includes a display item indicating the sources associated with the respective items. This enables a user associated with the account to view sources allocated to given record and/or item. Additionally, or alternatively, this enables the user to view portions of a total resource amount associated with a record that have been allocated to respective sources. As a result, the user may be enabled to initiate a correction of the allocated portions before contributions, from the respective sources, are obtained.

The machine learning analysis of the record described herein conserves processing resources, memory resources, computing resources, and/or network resources, among other examples, that would have otherwise been used to make determinations associated with the record using the data indicated by the record (e.g., at the first level of data or a less granular level of data). Further, the machine learning analysis of the record described herein conserves processing resources, memory resources, computing resources, and/or network resources, among other examples, that would have otherwise been used to obtain data associated with the record at the second level of data (e.g., communicate with another device to receive or otherwise obtain data at the second level of data) to enable the system to make determinations associated with the record using the more granular data.

Additionally, the machine learning analysis of the record described herein enables a rule-based approach for allocating resource amounts of a given exchange among multiple sources without intervening in the exchange itself. For example, rather than rejecting, declining, or otherwise preventing the exchange from being completed if item-level data does not meet criteria indicated by a rule set, the system may allocate portion(s) of the exchange accordingly to respective sources. As a result, additional processing during the process of the exchange is reduced, thereby reducing processing resources and/or network resources associated with performing the exchange and reducing a latency (e.g., that would have otherwise been associated with an amount of time needed for the system to perform processing associated with a rule-based approach during the process of completing the exchange) associated with completing the exchange. Further, this conserves processing resources, memory resources, computing resources, and/or network resources, among other examples, that would have otherwise been used to determine why an exchange is rejected, declined, or otherwise prevented from occurring, and/or attempting to perform or complete the exchange again, among other examples.

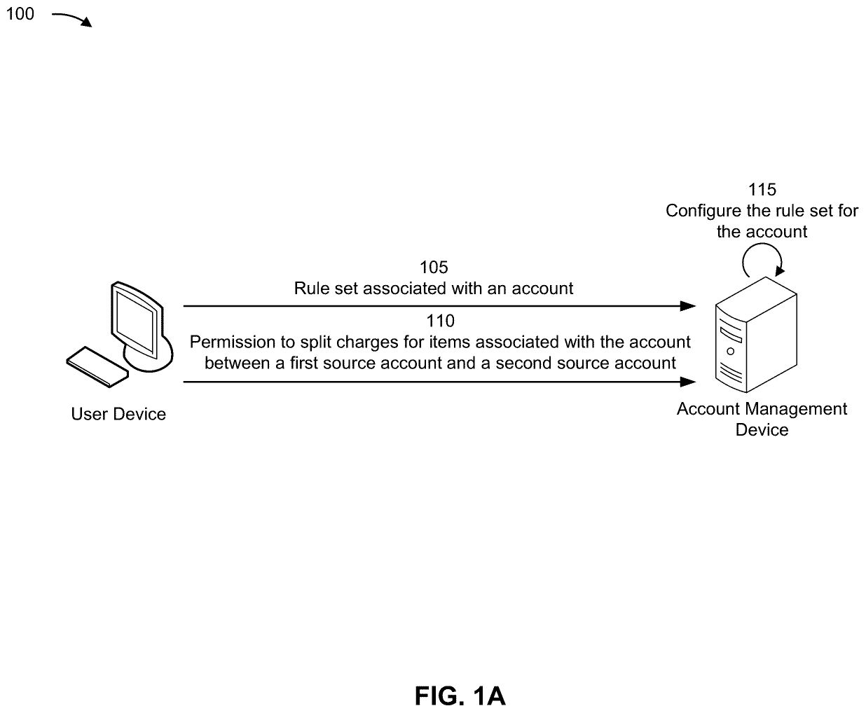

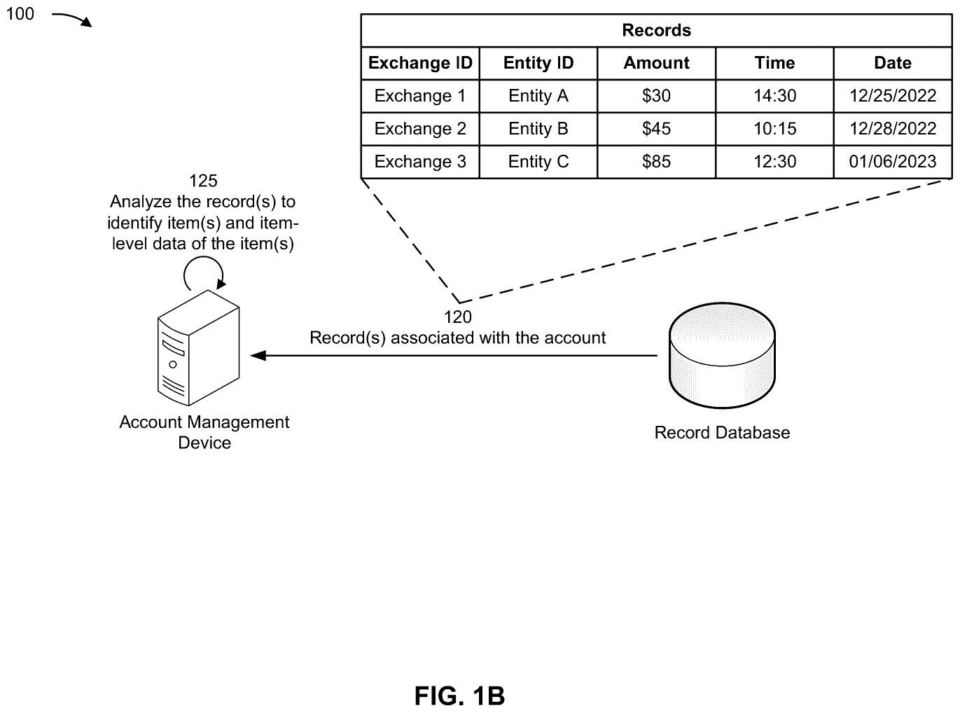

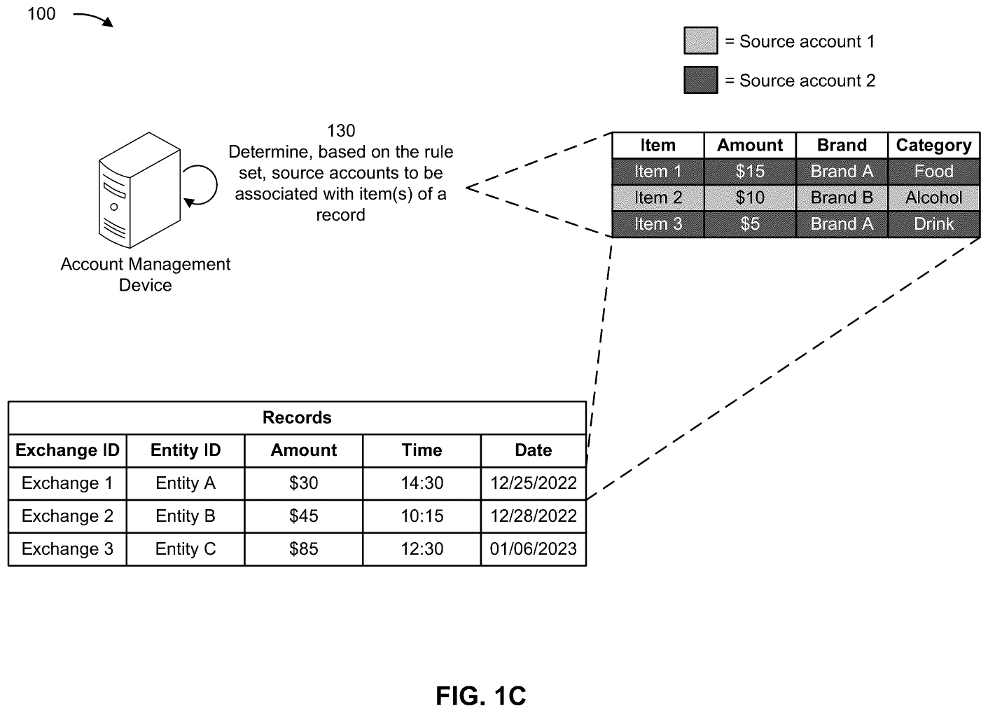

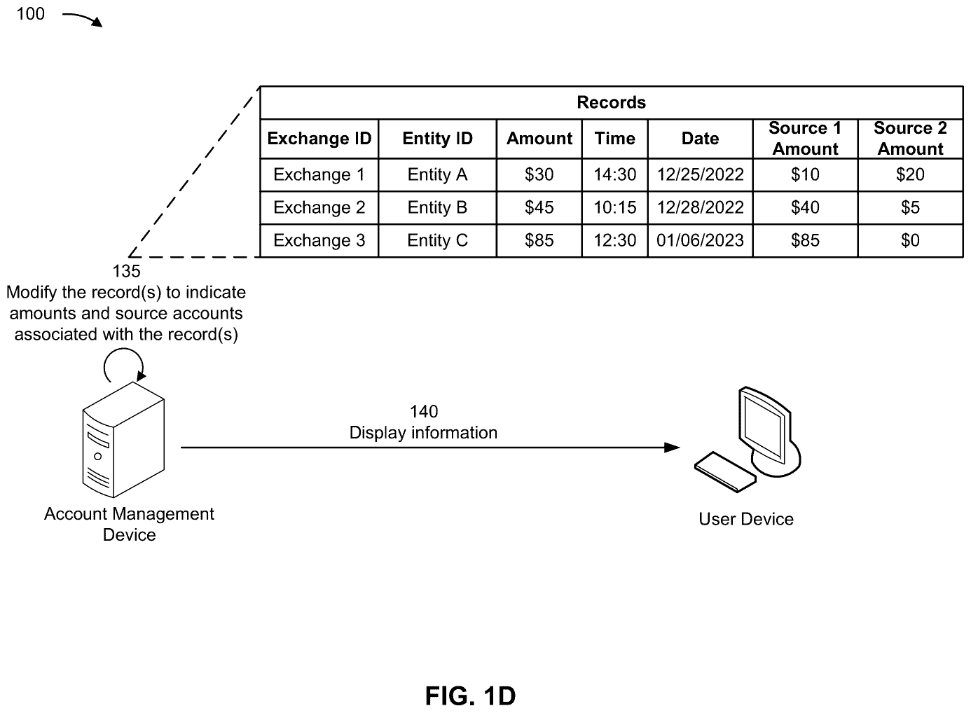

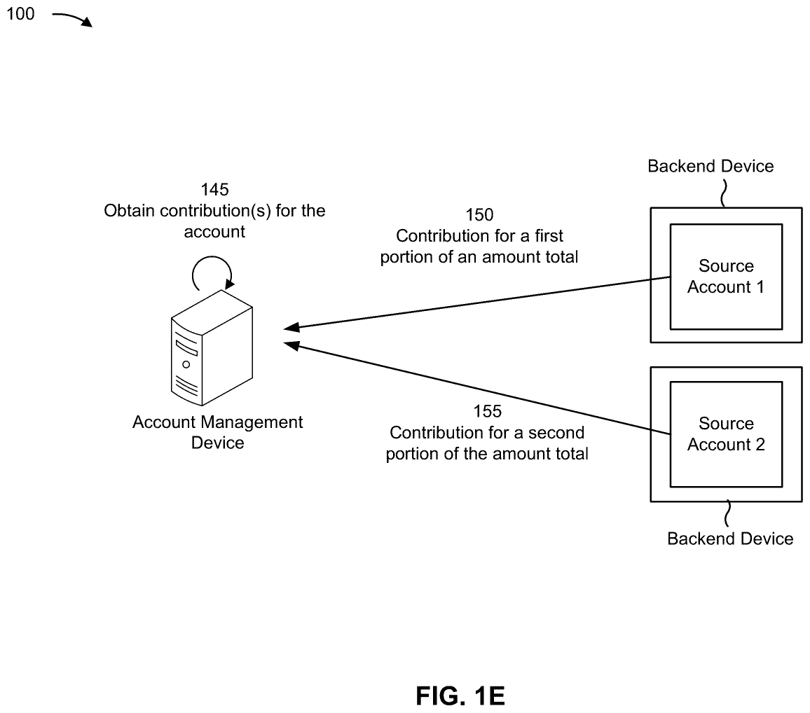

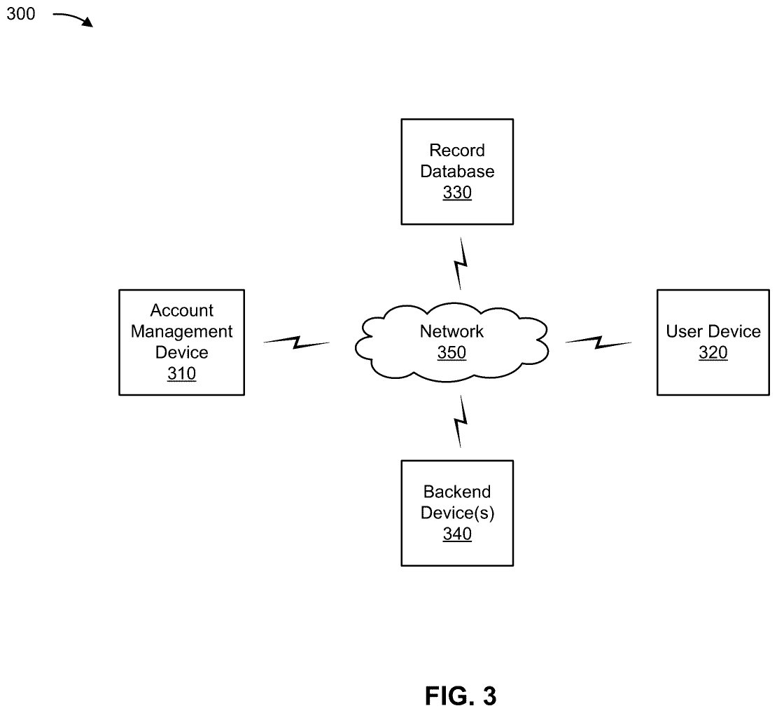

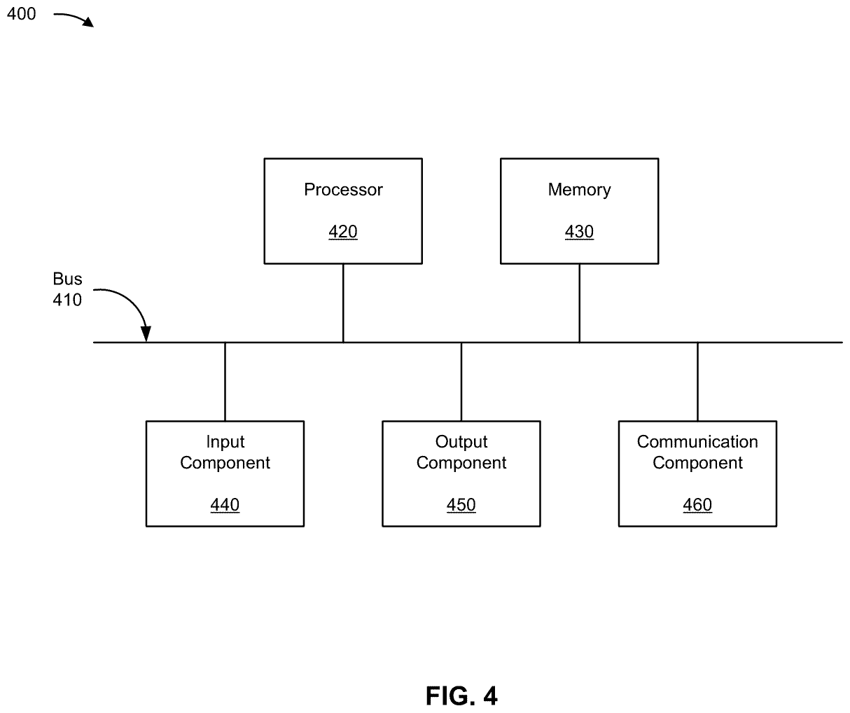

FIGS. 1A-1E are diagrams of an example 100 associated with machine learning analysis of a record. As shown in FIGS. 1A-1E, example 100 includes a user device, an account management device, a record database, and/or one or more backend devices. These devices are described in more detail in connection with FIGS. 3 and 4.

As used herein, “exchange” may refer to a transaction, an electronic exchange, a transaction, a sale, and/or a transfer, among other examples. For example, “exchange” and “transaction” may be used interchangeably herein. As used herein, a “source” may refer to an account that is associated with funding or crediting another account. For example, as used herein, a source may be referred to as a source account or a source funding account. As an example, an account may be a transaction account or a credit account, and a source of the account may be a bank account or another account that is associated with providing payments or contributions toward a total balance of the account. In some implementations, an account may be associated with multiple source accounts.

As shown in FIG. 1A, and by reference number 105, the account management device may obtain or retrieve a rule set associated with an account. As shown in FIG. 1A, the account management device may obtain or retrieve the rule set from the user device. For example, the user device may be associated with a user that is associated with the account. For example, the user may input the rule set to the user device and the user device may provide an indication of the rule set to the account management device. As another example, the account management device may obtain or retrieve the rule set from a database or another device, such as a database or device of an institution associated with the account.

The rule set may indicate one or more rules for associating a source account with an item indicated by a record (e.g., an exchange record) based on item-level of data of the item. As used herein, “item-level” data may refer to information or data associated with a given item. “Exchange-level” data may refer to information or data associated with a given exchange (e.g., where the exchange may be associated with one or more items). For example, the rule set may indicate one or more rules for allocating an amount (e.g., a purchase amount or a cost) of an item to a given source account from multiple source accounts associated with the account.

In some implementations, the one or more rules may indicate the source account to be associated with the item based on a category of the item. For example, the one or more rules may indicate one or more prohibited categories, such as alcoholic beverages, travel purchases, a given type of food, and/or gambling purchases (e.g., exchanges for lottery tickets or associated with a casino), among other examples. Additionally, or alternatively, the one or more rules may indicate one or more allowed categories, such as groceries, gasoline, utilities (e.g., associated with a utility provider, such as an electric company or other utility provider), and/or housing (e.g., rent payments or mortgage payments), among other examples. For example, if the category of an item is included in the one or more prohibited categories, then a rule may indicate that the cost or amount associated with item should be allocated to a first source account. If the category of an item is not included in the one or more prohibited categories, then the rule may indicate that the cost or amount associated with item should be allocated to a second source account. As another example, if the category of an item is included in the one or more allowed categories, then a rule may indicate that the cost or amount associated with item should be allocated to the second source account. If the category of an item is not included in the one or more allowed categories, then the rule may indicate that the cost or amount associated with item should be allocated to the first source account.

Additionally, or alternatively, the one or more rules may indicate the source account to be associated with the item based on a brand of the item. For example, a rule may indicate that if the brand of the item is a generic brand (e.g., a “store” brand), then the cost or amount associated with item should be allocated to the second source account. For example, a generic brand may be a brand of consumer products distinguished by the absence of a brand name, instead identified solely by product characteristics. If the brand of the item is not a generic brand (e.g., a “store” brand), then the rule may indicate that the cost or amount associated with item should be allocated to the first source account.

Additionally, or alternatively, the one or more rules may indicate the source account to be associated with the item based on a producer (e.g., manufacturer, maker, grower, and/or creator) of an item. For example, the one or more rules may indicate one or more prohibited producers. Additionally, or alternatively, the one or more rules may indicate one or more allowed producers. For example, if the producer of an item is included in the one or more prohibited producers, then a rule may indicate that the cost or amount associated with item should be allocated to the first source account. If the producer of an item is not included in the one or more prohibited producers, then the rule may indicate that the cost or amount associated with item should be allocated to a second source account. As another example, if the producer of an item is included in the one or more allowed producers, then a rule may indicate that the cost or amount associated with item should be allocated to the second source account. If the producer of an item is not included in the one or more allowed producers, then the rule may indicate that the cost or amount associated with item should be allocated to the first source account.

Additionally, or alternatively, the one or more rules may indicate the source account to be associated with the item based on an entity associated with an exchange that is associated with the item. For example, the one or more rules may indicate one or more prohibited entities. Additionally, or alternatively, the one or more rules may indicate one or more allowed entities.

For example, if the entity associated with the exchange is included in the one or more prohibited entities, then a rule may indicate that the cost or amount associated with item should be allocated to the first source account. If the if the entity associated with the exchange is not included in the one or more prohibited entities, then the rule may indicate that the cost or amount associated with item should be allocated to the second source account. As another example, if the entity associated with the exchange is included in the one or more allowed entities, then a rule may indicate that the cost or amount associated with item should be allocated to the second source account. If the entity associated with the exchange is not included in the one or more allowed entities, then the rule may indicate that the cost or amount associated with item should be allocated to the first source account.

Additionally, or alternatively, the one or more rules may indicate the source account to be associated with the item based on a cost of the item. For example, the one or more rules may indicate a cost threshold for an item. If a cost of the item satisfies the cost threshold, then a rule may indicate that the cost associated with item should be allocated to the first source account. If the cost of the item does not satisfy the cost threshold, then the rule may indicate that the cost associated with item should be allocated to the second source account. In some implementations, the rule set may indicate multiple cost thresholds. For example, the multiple cost thresholds may be associated with respective categories or brands of items. In other words, the rule set may indicate a cost threshold for a given category or brand of items.

Additionally, or alternatively, the one or more rules may indicate the source account to be associated with the item based on nutritional content information associated with the item. For example, an item (e.g., a food item) may be associated with nutrients or dietary substances in the item. For example, the nutritional content information may include an indication of an amount of a given nutrient, dietary supplement, and/or ingredient included in an item (e.g., in terms of weight, such as in grams, and/or in terms of a percentage of a daily value). A rule may indicate a nutritional content threshold for a given nutrient, dietary supplement, and/or ingredient included in an item, such as a sugar content threshold, a sodium content threshold, a calorie content threshold, and/or a total fat content threshold, among other examples. If an amount of the given nutrient associated with an item satisfies the nutritional content threshold, then the rule may indicate that the cost associated with item should be allocated to the first source account. If the amount of the given nutrient associated with an item does not satisfy the nutritional content threshold, then the rule may indicate that the cost associated with item should be allocated to the second source account.

In some implementations, the rule set may indicate parameters for an applicability of the rule set. For example, the rule set may indicate that the account management device is to apply the rule set for allocating amounts of exchanges to respective source accounts based on a location associated with an exchange. For example, an application of the rule set to determine the sources associated with the respective items may be based on the location being outside of or being inside of a geographic region (e.g., indicated by the rule set). As another example, the rule set may indicate that the account management device is to apply the rule set for allocating amounts of exchanges to respective source accounts based on whether a sum of amounts of exchanges associated with the account, over a time interval, satisfies an exchange threshold. For example, if the sum of amounts of exchanges associated with the account, over the time interval, satisfies the exchange threshold, then the rule set may indicate that the rule set no longer applies and that all future exchanges (e.g., during the remaining amount of time in the time interval) are to be associated with a given source account.

In some implementations, the rule set may indicate that the account management device is to apply the rule set for allocating amounts of exchanges to respective source accounts based on a timing associated with an exchange. For example, an application of the rule set to determine the source accounts associated with the respective items may be based on a time of an exchange being included in an allowable time period. For example, the account management device may determine, based on exchange-level data, a time associated with an exchange that is associated with a record. The allowable time period may be a time of day (e.g., the allowable time period may be between 7:00 AM and 10:00 PM) and/or a particular day of the week (e.g., the allowable time period may include Mondays, Tuesdays, Wednesdays, Thursdays, and Fridays).

In some implementations, an application of the rule set to determine the source accounts associated with the respective items may be based on obtaining permission from a manager or other user of the account. For example, a first source account may be associated with an account owner of the account (e.g., the manager of the account). A second source account may be associated with an authorized user of the account. For example, the authorized user may be a dependent of the owner of the account (e.g., a child of the owner of the account or another dependent of the owner) and/or may be otherwise granted permission to use resources (e.g., credit) of the account to complete exchanges. As shown by reference number 110, the user device may provide, and the account management device may obtain, permission to split charges for items associated with the account between a first source account and a second source account (e.g., permission to apportion charges of the account between the first source account and the second source account). The account management device may determine to apply the rule set based on obtaining the permission.

As shown by reference number 115, the account management device may configure the rule set for the account. For example, the account management device may configure one or more rules indicated by the rule set in a memory or data structure associated with the account management device. In some implementations, the account management device may configure the one or more rules to cause the account management device to allocate an amount of an exchange associated with the account to be apportioned to the first source account, the second source account, and/or split between the first source account and the second source account, in accordance with the one or more rules (e.g., based on item-level data of one or more items associated with the exchange).

As shown in FIG. 1B, and by reference number 120, the account management device may obtain or retrieve, from the record database, an indication of one or more records associated with the account. For example, a record may be associated with a given exchange. A record may also be referred to as an exchange record or a transaction record. The record database may be associated with an institution (e.g., a financial institution) that provides or manages the account. A record may indicate data at a first level of data (e.g., a first level of granularity). For example, the record may indicate exchange-level data associated with an exchange. For example, a record may be associated with a completed exchange that is associated with the one or more items. For example, as shown in FIG. 1B, a record may indicate an identifier of an exchange, an entity (e.g., entity ID) associated with the exchange, a total amount (e.g., shown as “amount” in FIG. 1B) associated with the exchange, a time associated with the exchange, and/or a date associated with the exchange, among other examples. In other words, a record may indicate data associated with a given exchange, but may not provide data associated with an item or service purchased as part of the exchange. For example, it may be difficult for the account management device to discern item-level data associated with an item or service purchased as part of the exchange from the data indicated by the record.

As shown by reference number 125, the account management device may analyze data associated with a record (e.g., included in the record), of the one or more records, to determine item-level data for respective items of one or more items associated with the record. In some implementations, the determine item-level data for respective items of one or more items associated with the record based on item-level data stored in a database or data structure. For example, the account management device may search an item-level database using data included in the record. For example, the data included in the record may include identifiers of items, such as a stock keeping unit (SKU) or another identifier. The account management device may search the item-level database using identifier(s) of item(s) associated with the record to identify the item-level data. For example, the account management device may obtain the item-level data for the respective items based on searching the item-level database using the data included in the record.

As another example, the account management device may analyze, using a machine learning model, the data included in the record to determine the item-level data. For example, the account management device may provide, to the machine learning model, the data included in the record. The account management device may obtain, from the machine learning model, an output indicating at least a portion of the item-level data for respective items of an exchange associated with the record. For example, the machine learning model may be trained using a training data set that includes exchange-level data indicated by records and respective item-level data (e.g., that is manually input) of respective items associated with the records.

In some implementations, the machine learning model may include a pattern recognition model that determines different factors associated with the exchange-level data and weights for the different factors. In some implementations, the account management device may perform a training operation on the machine learning model with historical data. The historical data may include exchange-level data indicated by records and respective item-level data (e.g., that is manually input) of respective items associated with the records. In some implementations, the account management device may separate the historical data into a training set, a validation set, and/or a test set, among other examples. The training set may be utilized to the train the machine learning model. The validation set may be utilized to validate results of the trained machine learning model. The test set may be utilized to test operations of the machine learning model. In some implementations, the account management device may train the machine learning model using, for example, an unsupervised training procedure and based on the historical data. For example, the account management device may perform dimensionality reduction to reduce the historical data to a minimum feature set, thereby reducing resources (e.g., processing resources, memory resources, and/or the like) to train the machine learning model, and may apply a classification technique, to the minimum feature set.

In some implementations, the account management device may use a logistic regression classification technique to determine a categorical outcome (e.g., different factors associated with the exchange-level data and weights for the different factors). Additionally, or alternatively, the account management device may use a naive Bayesian classifier technique. In this case, the account management device may perform binary recursive partitioning to split the historical data into partitions and/or branches and use the partitions and/or branches to perform predictions (e.g., different factors associated with the exchange-level data and weights for the different factors). Based on using recursive partitioning, the account management device may reduce utilization of computing resources relative to manual, linear sorting and analysis of data points, thereby enabling use of thousands, millions, or billions of data points to train the machine learning model, which may result in a more accurate model than using fewer data points.

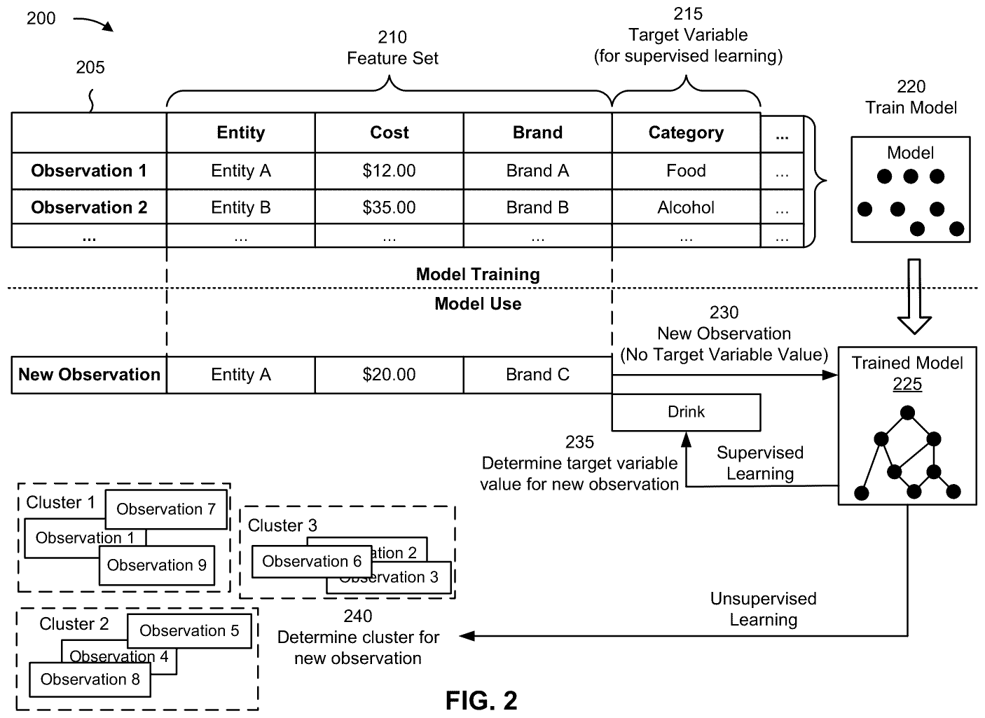

Additionally, or alternatively, the account management device may train the machine learning model using a supervised training procedure that includes receiving input to the machine learning model from a subject matter expert, which may reduce an amount of time, and/or an amount of processing resources, among other examples, to train the machine learning model of activity automatability relative to an unsupervised training procedure. In some implementations, the account management device may use one or more other model training techniques, such as a neural network technique, and/or a latent semantic indexing technique, among other examples. For example, the account management device may perform an artificial neural network processing technique (e.g., using a two-layer feedforward neural network architecture, or a three-layer feedforward neural network architecture) to perform pattern recognition with regard to patterns of the historical data. In this case, using the artificial neural network processing technique may improve an accuracy of the trained machine learning model generated by the account management device by making the trained model more robust to noisy, imprecise, or incomplete data, and by enabling the account management device to detect patterns and/or trends undetectable to human analysts or systems using less complex techniques. The training and use of the machine learning model is described in more detail in connection with FIG. 2.

The account management device may determine one or more items associated with a given record. For example, the account management device may analyze exchange-level data indicated by the record to determine the one or more items of an exchange associated with the record. For example, the exchange-level data may include an identifier or a SKU of one or more items associated with the record. The account management device may determine the one or more items based on the identifier(s) or the SKU(s) indicated by the record.

The account management device may obtain item-level data associated with one or more items for a given record associated with the account. For example, based on searching a database and/or an output of the machine learning model, the account management device may obtain the item-level data. The item-level data of an item may include a category, a brand, a seller (e.g., an entity associated with an exchange associated with the record), a producer, a manufacturer, a cost, SKU-level data, geographic location information, and/or nutritional content information, among other examples.

As shown in FIG. 1C, and by reference number 130, the account management device may determine, based on the rule set, source accounts to be associated with respective item(s) of a record. For example, the account management device may determine, based on the rule set and item-level data of an item associated with an exchange (e.g., that is associated with the record), a source account to be associated with the item. The determined source account may be responsible for funding or paying a credit or debt associated with the item. For example, the account management device may allocate a cost associated with the item to the determined source account, as described elsewhere herein.

For example, the account management device may apply the one or more rules included in the rule set to the item-level data of a given item to determine a source account to be associated with the item. For example, as shown in FIG. 1C, an exchange (e.g., the exchange 1) may be associated with an item 1, an item 2, and an item 3. The account management device may determine, based on the rule set, that the item 2 is to be associated with a source account 1 (e.g., a first source account associated with the account). The account management device may determine, based on the rule set, that the item 1 and the item 3 are to be associated with a source account 2 (e.g., a second source account associated with the account). For example, the rule set may include a rule indicating that a category of “Alcohol” is a prohibited category. Therefore, the account management device may allocate a cost (e.g., “Amount”) of the item 2 (e.g., associated with the category of alcohol) to the source account 1. The rule set may indicate that a brand of “Brand A” is an allowed brand and/or is not a prohibited brand. Similarly, the rule set may indicate that the categories of “Food” and “Drink” are allowed categories and/or are not prohibited categories. Therefore, the account management device may allocate a cost of the item 1 and the item 3 to the source account 2. For example, for the exchange 1 and from the total amount of $30, the account management device may determine (e.g., based on the rule set and the item-level data) that $10 is to be associated with (e.g., to be paid via) the source account 1 and $20 is to be associated with (e.g., to be paid via) the source account 2. The account management device may determine source account(s) for other records and/or exchanges in a similar manner. For example, one or more rules, such as the example rules described in connection with FIG. 1A, may be used to determine a source account for each item associated with an exchange. In some examples, an entire amount or cost of an exchange may be associated with a single source account (e.g., in cases where all items are determined to be associated with the same source account).

As shown in FIG. 1D, and by reference number 135, the account management device may modify the record(s) to indicate amounts and source accounts associated with the record(s). For example, the account management device may modify, based on determining the source accounts to be associated with the respective items, the record to indicate the source accounts associated with the respective items and/or a portion of an amount associated with the record allocated to the source accounts. For example, as shown in FIG. 1D, the record may be modified to include a “Source 1 Amount” field and a “Source 2 Amount” filed associated with indicating portions of an amount of the record allocated to the respective source accounts. The account management device may insert a portion of an amount of the exchange into a corresponding field of a record associated with the exchange for each source account. For example, as shown in FIG. 1D, the resource for the exchange 1 may be modified to indicate that $10 is associated with the source account 1 (e.g., in the “Source 1 Amount” field) and to indicate that $20 is associated with the source account 2 (e.g., in the “Source 2 Amount” field). In some implementations, the record may be modified to indicate a source account determined to be associated with each item associated with the account (e.g., similar to the information depicted in FIG. 1C).

The account management device may store in a data structure associated with the account (e.g., in the record database), the record indicating the sources associated with the respective items. For example, the account management device may store the modified record in the record database. This enables the account management device to track and/or maintain portions of a total amount (or total credit used) for the account that are associated with respective source accounts.

In some implementations, as shown by reference number 140, the account management device may provide (e.g., to the user device or another device) display information. The display information may cause a user interface to be displayed (e.g., by the user device or the other device). For example, the display information may identify content for a document object (e.g., a webpage or page of an application requested by the user device) of the user interface. The document object may be associated with a document object model (DOM) that includes code for generating the document object (e.g., the webpage or the page of the application).

The user interface may include a display item indicating the source accounts associated with the respective items. In some implementations, the user interface may include a display item indicating an amount, of a total amount associated with the account, apportioned each source account. For example, a display item may indicate a source account 1 total amount which may be a sum of the values in the “Source 1 Amount” field for all records associated with the account. Similarly, a display item may indicate a source account 2 total amount which may be a sum of the values in the “Source 2 Amount” field for all records associated with the account.

The display items may be displayed in connection with the exchange-level data originally included in the records. This enables a user to quickly locate informational content of interest without navigating away from a page of the user interface and without following numerous links from the page. In this way, computing resources and/or network resources may be conserved by reducing an amount of navigation performed by the user. Furthermore, the user interface described herein makes data easier to access by enhancing the user interface by including the display items, thereby improving a user experience, enhancing user-friendliness of the user device and the user interface. For example, the user may be enabled to quickly identify an amount apportioned for each source account associated with the account.

As shown in FIG. 1E, and by reference umber 145, the account management device may obtain contributions for the account. For example, the account management device may obtain, based on the sources associated with the respective items, a contribution toward a total resource amount associated with the account (e.g., a total amount owed for exchanges completed associated with the account). For example, as shown by reference number 150, the account management device may obtain, from the first source account, a first contribution associated with a first portion of the total resource amount. As shown by reference number 155, the account management device may obtain, from the second source account, a second contribution associated with a first portion of the total resource amount.

The first portion may be based on amounts of first items, associated with the one or more records, determined to be associated with the first source account based on the rule set and item-level data of the first items (e.g., may be a sum of values in the “Source 1 Amount” field depicted in FIG. 1D). Similarly, the second portion may be based on amounts of second items, associated with the one or more records, determined to be associated with the second source account based on the rule set and item-level data of the second items (e.g., may be a sum of values in the “Source 2 Amount” field depicted in FIG. 1D). For example, the account management device may communicate with backend devices associated with respective source accounts to obtain the contribution of the portion of the total resource amount. In some implementations, the backend devices may be different devices (e.g., associated with different institutions).

In some implementations, the account management device may use or provide information associated with a payment history for at least one of the source accounts for determining credit worthiness and/or as part of a credit application process. For example, a source account may be associated with an authorized user that may not have enough credit history to successfully obtain their own account. The account management device may use contributions from a source account associated with the authorized user to determine credit worthiness and/or as part of a credit application process for the authorized user. For example, the account management device may determine a payment history associated with the contributions (e.g., whether the contributions were made on time and/or made in whole) to determine a credit worthiness (e.g., a credit score) and/or to determine whether to approve a credit card application associated with the authorized user. The payment history associated with the contributions may provide valuable insight into the credit worthiness of the authorized user that would otherwise have been unavailable, enabling the account management device to make improved determinations regarding the credit worthiness of the authorized user.

As indicated above, FIGS. 1A-1E are provided as an example. Other examples may differ from what is described with regard to FIGS. 1A-1E.

FIG. 2 is a diagram illustrating an example 200 of training and using a machine learning model in connection with machine learning analysis of a record. The machine learning model training and usage described herein may be performed using a machine learning system. The machine learning system may include or may be included in a computing device, a server, a cloud computing environment, or the like, such as the account management device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the record database, a user device, a memory of the account management device, and/or another device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the record database, a user device, a memory of the account management device, and/or another device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of entity, a second feature of cost, a third feature of brand, and so on. As shown, for a first observation, the first feature may have a value of Entity A, the second feature may have a value of $12.00, the third feature may have a value of Brand A, and so on. These features and feature values are provided as examples, and may differ in other examples. For example, the feature set may include one or more of the following features: exchange-level data, an identifier of an exchange, an entity associated with the exchange, a total amount associated with the exchange, a time associated with the exchange, a date associated with the exchange, and/or an identifier of an item (e.g., a SKU of an item), among other examples.

As shown by reference number 215, the set of observations may be associated with a

target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is category, which has a value of Food for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, the machine learning system may use a naive Bayesian classifier technique. In this case, the machine learning system may perform binary recursive partitioning to split the set of observations into partitions and/or branches and use the partitions and/or branches to perform predictions (e.g., different factors associated with the exchange-level data and weights for the different factors). After training, the machine learning system may store the machine learning model as a trained machine learning model 225 to be used to analyze new observations.

As an example, the machine learning system may obtain training data for the set of observations based on exchange-level data indicated by records (e.g., transaction records) and respective item-level data (e.g., that may be manually input) of respective items associated with the records. For example, the machine learning system may obtain the training data from the record database and/or another device, such as the account management device.

As shown by reference number 230, the machine learning system may apply the trained machine learning model 225 to a new observation, such as by receiving a new observation and inputting the new observation to the trained machine learning model 225. As shown, the new observation may include a first feature of entity, a second feature of cost, a third feature of brand, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of Drink for the target variable of category for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, associating an item associated with the new observation with a given source account. The first automated action may include, for example, causing a cost of the item to be associated with the given source account.

As another example, if the machine learning system were to predict a value of Alcohol for the target variable of category, then the machine learning system may provide a second (e.g., different) recommendation (e.g., to associate an item associated with the new observation with a different source account) and/or may perform or cause performance of a second (e.g., different) automated action (e.g., causing a cost of the item to be associated with the different source account).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., allowable categories as indicated by a rule set), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., prohibited categories as indicated by the rule set), then the machine learning system may provide a second (e.g., different) recommendation (e.g., the second recommendation) and/or may perform or cause performance of a second (e.g., different) automated action, such as the second automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include whether a contribution for the item is obtained from a determined source account (e.g., indicating that the predicted item-level data was correct), and/or an indication from a user device that a portion of an exchange was incorrectly allocated (e.g., indicating that the predicted item-level data was incorrect), among other examples.

In this way, the machine learning system may apply a rigorous and automated process to analysis of a record to determine item-level data associated with the record. The machine learning system may enable recognition and/or identification of tens, hundreds, thousands, or millions of features and/or feature values for tens, hundreds, thousands, or millions of observations, thereby increasing accuracy and consistency and reducing delay associated with analyzing a record to determine item-level data associated with the record relative to requiring computing resources to be allocated for tens, hundreds, or thousands of operators to manually analyze the record to determine the item-level data associated with the record using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an account management device 310, a user device 320, a record database 330, one or more backend device 340, and/or a network 350. Devices of environment 300 may interconnect via wired connections, wireless connections, or a combination of wired and wireless connections.

The account management device 310 may include one or more devices capable of receiving, generating, storing, processing, providing, and/or routing information associated with machine learning analysis of a record, as described elsewhere herein. The account management device 310 may include a communication device and/or a computing device. For example, the account management device 310 may include a server, such as an application server, a client server, a web server, a database server, a host server, a proxy server, a virtual server (e.g., executing on computing hardware), or a server in a cloud computing system. In some implementations, the account management device 310 may include computing hardware used in a cloud computing environment.

The user device 320 may include one or more devices capable of receiving, generating, storing, processing, and/or providing information associated with machine learning analysis of a record, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a wearable communication device (e.g., a smart wristwatch, a pair of smart eyeglasses, a head mounted display, or a virtual reality headset), or a similar type of device.

The record database 330 may include one or more devices capable of receiving, generating, storing, processing, and/or providing information associated with machine learning analysis of a record, as described elsewhere herein. The record database 330 may include a communication device and/or a computing device. For example, the record database 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the record database 330 may store one or more records, an indication of source accounts associated with a given record, and/or portions of a total amount of a record and/or an account associated with respective source accounts, as described elsewhere herein.

The backend device 340 may include one or more devices capable of receiving, generating, storing, processing, providing, and/or routing information associated with machine learning analysis of a record, as described elsewhere herein. The backend device 340 may include a communication device and/or a computing device. For example, the backend device 340 may include a server, such as an application server, a client server, a web server, a database server, a host server, a proxy server, a virtual server (e.g., executing on computing hardware), or a server in a cloud computing system. In some implementations, the backend device 340 may include computing hardware used in a cloud computing environment. In some implementations, the backend device 340 may include one or more servers and/or computing hardware (e.g., in a cloud computing environment or separate from a cloud computing environment) configured to receive and/or store information associated with processing an electronic transaction. The backend device 340 may process a transaction, such as to approve (e.g., permit, authorize, or the like) or decline (e.g., reject, deny, or the like) the transaction and/or to complete the transaction if the transaction is approved. The backend device 340 may be associated with a financial institution (e.g., a bank, a lender, a credit card company, or a credit union) and/or may be associated with a transaction card association that authorizes a transaction and/or facilitates a transfer of funds. For example, the backend device 340 may be associated with an issuing bank associated with the transaction device, an acquiring bank (or merchant bank) associated with the merchant and/or the transaction terminal, and/or a transaction card association (e.g., VISA® or MASTERCARD®) associated with the transaction device. Based on receiving information associated with a contribution, one or more devices of the backend device 340 may communicate to authorize a transaction and/or to transfer funds from a source account associated with the backend device 340 to an account of an entity associated with an account, as described herein.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with machine learning analysis of a record. The device 400 may correspond to the account management device 310, the user device 320, the record database 330, and/or the backend device(s) 340. In some implementations, the account management device 310, the user device 320, the record database 330, and/or the backend device(s) 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430. The input component 440 may enable the device 400 to receive input, such as user

input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

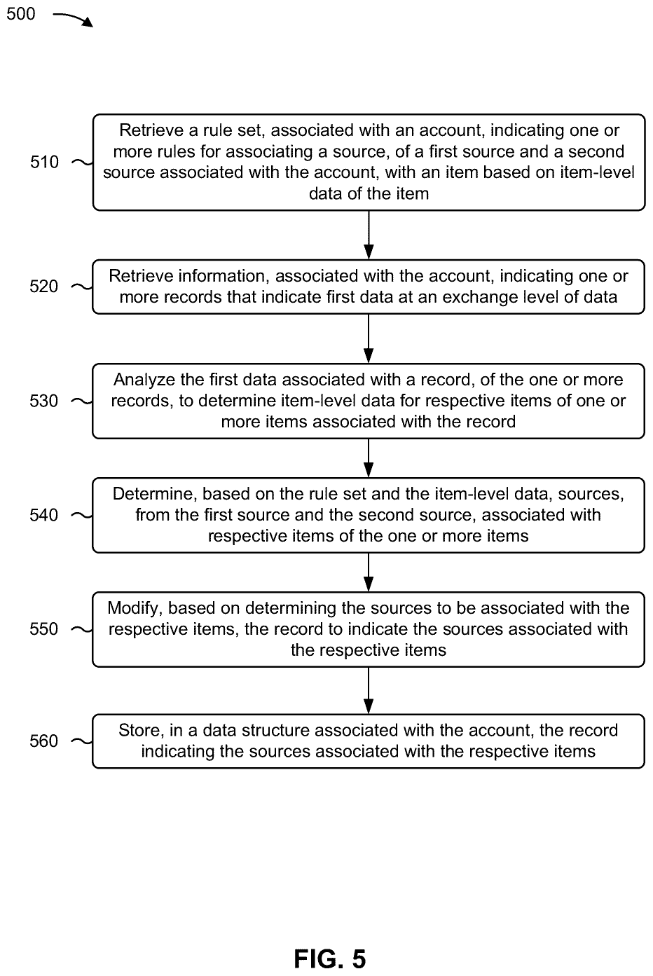

FIG. 5 is a flowchart of an example process 500 associated with machine learning analysis of a record. In some implementations, one or more process blocks of FIG. 5 may be performed by the account management device 310. In some implementations, one or more process blocks of FIG. 5 may be performed by another device or a group of devices separate from or including the account management device 310, such as the user device 320, the record database 330, and/or the backend device(s) 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include retrieving a rule set, associated with an account, indicating one or more rules for associating a source, of a first source and a second source associated with the account, with an item based on item-level data of the item (block 510). For example, the account management device 310 (e.g., using processor 420 and/or memory 430) may retrieve a rule set, associated with an account, indicating one or more rules for associating a source, of a first source and a second source associated with the account, with an item based on item-level data of the item, as described above in connection with reference number 105 of FIG. 1A. As an example, the rule set may indicate one or more rules to define which source (e.g., source account), from multiple source accounts associated with the account, is to be associated with a given item. If a source account is associated with an item, then the source account may be responsible for contributing an amount associated with the source as a payment associated with the account. The one or more rules may be based on (or defined using) item-level data.

As further shown in FIG. 5, process 500 may include retrieving information, associated with the account, indicating one or more records that indicate first data at an exchange level of data (block 520). For example, the account management device 310 (e.g., using processor 420 and/or memory 430) may retrieve information, associated with the account, indicating one or more records that indicate first data at an exchange level of data, as described above in connection with reference number 120 of FIG. 1B. As an example, the account management device 310 may obtain a record of a completed exchange associated with the account (e.g., from the record database 330).

As further shown in FIG. 5, process 500 may include analyzing the first data associated with a record, of the one or more records, to determine item-level data for respective items of one or more items associated with the record (block 530). For example, the account management device 310 (e.g., using processor 420 and/or memory 430) may analyze the first data associated with a record, of the one or more records, to determine item-level data for respective items of one or more items associated with the record, as described above in connection with reference number 125 of FIG. 1B. As an example, the account management device 310 may use a machine learning model to analyze the first data (e.g., included in the record) to determine the item-level data. For example, the account management device 310 may use the machine learning model in a similar manner as described in connection with FIGS. 1A-1E and 2.

As further shown in FIG. 5, process 500 may include determining, based on the rule set and the item-level data, sources, from the first source and the second source, associated with respective items of the one or more items (block 540). For example, the account management device 310 (e.g., using processor 420 and/or memory 430) may determine, based on the rule set and the item-level data, sources, from the first source and the second source, associated with respective items of the one or more items, as described above in connection with reference number 130 of FIG. 1C. As an example, the account management device 310 may apply the one or rules to item-level data for a given item to determine a source (e.g., a source account) to be associated with the item. The account management device 310 may determine a source (e.g., a source account) to be associated with each item that is associated with a given record (e.g., based on the rule set). For example, the account management device 310 may determine whether a category of an item is indicated as an allowed category by the rule set. If the category is an allowed category, then the account management device 310 may determine that the item is to be associated with the first source. If the category is not an allowed category (e.g., is a prohibited category), then the account management device may determine that the item is to be associated with the second source. In some implementations, the account management device may determine portions of a total amount of a record to be associated with respective sources (e.g., based on determining sources for each item associated with the record).

As further shown in FIG. 5, process 500 may include modifying, based on determining the sources to be associated with the respective items, the record to indicate the sources associated with the respective items (block 550). For example, the account management device 310 (e.g., using processor 420 and/or memory 430) may modify, based on determining the sources to be associated with the respective items, the record to indicate the sources associated with the respective items, as described above in connection with reference number 135 of FIG. 1D. As an example, the account management device 310 may modify the record to indicate sources associated with respective items that are associated with the record and/or to indicate portions of a total amount of a record to be associated with respective sources (e.g., a portion of the total amount of the record allocated to each source account).

As further shown in FIG. 5, process 500 may include storing, in a data structure associated with the account, the record indicating the sources associated with the respective items (block 560). For example, the account management device 310 (e.g., using processor 420 and/or memory 430) may store, in a data structure associated with the account, the record indicating the sources associated with the respective items, as described above in connection with FIG. 1D. As an example, the account management device 310 may store the modified record in the record database 330.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using machine learning to analyze records, the system comprising:
one or more memories; and
one or more processors, communicatively coupled to the one or more memories, configured to:
retrieve a rule set, associated with an account, indicating one or more rules for associating a source, of a first source and a second source associated with the account, with an item based on a first level of data of the item;
retrieve information, associated with the account, indicating one or more records that indicate first data at a second level of data;
analyze, using a machine learning model, the first data in association with a record, of the one or more records, to determine second data, at the first level of data, for respective items of one or more items associated with the record;
determine, based on the rule set and the second data, sources, from the first source and the second source, associated with respective items of the one or more items;
modify, based on determining the sources to be associated with the respective items, the record to indicate the sources associated with the respective items; and
store, in a data structure associated with the account, the record indicating the sources associated with the respective items.

2. The system of claim 1, wherein the one or more processors are further configured to:
provide, to a user device, display information to cause a user interface to be displayed,
wherein the user interface includes a display item indicating the sources associated with the respective items.

3. The system of claim 1, wherein the record is associated with a completed exchange that is associated with the one or more items.

4. The system of claim 1, wherein the one or more rules indicate the source to be associated with the item based on at least one of:
a category of the item,
a brand of the item,
a producer of the item,
an entity associated with an exchange that is associated with the item,
a cost of the item, or
nutritional content information associated with the item.

5. The system of claim 1, wherein the one or more rules indicate the source to be associated with the item based on whether a sum of amounts of exchanges associated with the account, over a time interval, satisfies a threshold.

6. The system of claim 1, wherein the one or more processors are further configured to:
determine, based on the first data, a location associated with an exchange that is associated with the record,
wherein an application of the rule set to determine the sources associated with the respective items is based on the location being outside of or being inside of a geographic region.

7. The system of claim 1, wherein the one or more processors are further configured to:
obtain, from a user device associated with the account, permission to apportion charges of the account between the first source and the second source,
wherein an application of the rule set to determine the sources associated with the respective items is based on obtaining the permission.

8. The system of claim 1, wherein the first source is associated with a first contribution account associated with the account and the second source is associated with a second contribution account associated with the account.

9. A method for allocating sources to items associated with records, comprising:
retrieving, by a device, a rule set, associated with an account, indicating one or more rules for associating a source, of a first source and a second source associated with the account, with an item based on item-level data of the item;
retrieving, by the device, information, associated with the account, indicating one or more records that indicate first data at an exchange level of data;
analyzing, by the device, the first data associated with a record, of the one or more records, to determine item-level data for respective items of one or more items associated with the record;
determining, by the device and based on the rule set and the item-level data, sources, of the first source and the second source, associated with respective items of the one or more items;
modifying, by the device and based on determining the sources to be associated with the respective items, the record to indicate the sources associated with the respective items; and
storing, by the device and in a data structure associated with the account, the record indicating the sources associated with the respective items.

10. The method of claim 9, further comprising:
obtaining, based on the sources associated with the respective items, a contribution toward a total resource amount associated with the account.

11. The method of claim 10, wherein obtaining the contribution comprises:
obtaining, from the first source, a first contribution associated with a first portion of the total resource amount; and
obtaining, from the second source, a second contribution associated with a second portion of the total resource amount,
wherein the first portion is based on amounts of first items, associated with the one or more records, determined to be associated with the first source based on the rule set and item-level data of the first items, and
wherein the second portion is based on amounts of second items, associated with the one or more records, determined to be associated with the second source based on the rule set and item-level data of the second items.

12. The method of claim 9, wherein the record is associated with a completed exchange that is associated with the one or more items.

13. The method of claim 9, wherein the one or more rules indicate the source to be associated with the item based on stock keeping unit (SKU) level data of the item.

14. The method of claim 9, further comprising:
searching an item-level database using the first data; and
obtaining the item-level data for the respective items based on searching the item-level database using the first data.

15. The method of claim 9, wherein analyzing the first data comprises:
providing, to a machine learning model, the first data; and
obtaining, from the machine learning model, an output indicating the item-level data for the respective items.

16. The method of claim 9, further comprising:
determining, based on the first data, a time associated with an exchange that is associated with the record,
wherein an application of the rule set to determine the sources associated with the respective items is based on the time being included in an allowable time period.

17. A non-transitory computer-readable medium storing a set of instructions, the set of instructions comprising:
one or more instructions that, when executed by one or more processors of a device, cause the device to:
retrieve a rule set, associated with an account, indicating one or more rules for associating a source, of a first source and a second source associated with the account, with an item based on item-level data of the item;
retrieve information, associated with the account, indicating one or more records that indicate first data at an exchange-level of data;
analyze the first data associated with a record, of the one or more records, to determine item-level data for respective items of one or more items associated with the record;
determine, based on the rule set and the item-level data, sources, of the first source and the second source, associated with respective items of the one or more items;
modify, based on determining the sources to be associated with the respective items, the record to indicate the sources associated with the respective items; and
obtain, based on modifying the record, a contribution toward a total resource amount associated with the account,
wherein the contribution includes a first contribution of a first portion of the total resource amount from the first source and a second contribution of a second portion of the total resource amount from the second source.

18. The non-transitory computer-readable medium of claim 17, wherein the first portion is based on amounts of first items, associated with the one or more records, determined to be associated with the first source based on the rule set and item-level data of the first items, and wherein the second portion is based on amounts of second items, associated with the one or more records, determined to be associated with the second source based on the rule set and item-level data of the second items.

19. The non-transitory computer-readable medium of claim 17, the one or more rules indicate the source to be associated with the item based on at least one of:
a category of the item,
a brand of the item, or
a producer of the item.

20. The non-transitory computer-readable medium of claim 17, wherein the one or more instructions, that cause the device to analyze the first data, cause the device to:
provide, to a machine learning model, the first data; and
obtain, from the machine learning model, an output indicating the item-level data for the respective items.
